(19) United States
(12) Patent Application Publication
(10) Pub. No.: US 2007/0247279 A1
(43) Pub. Date: Oct. 25, 2007

(54) Method of unauthorized access prevention to a restricted object and a biometric security identification system

(76) Inventor: Vladimir Safonov, Montreal (CA)

Correspondence Address: SAFONOV Vladimir, 2320 St. JACQUES, MONTREAL, QC, H3J 2M7, CA

(21) Appl. No.: 11/391,382

(22) Filed: Mar. 29, 2006

(51) Int. Cl. G05B 19/00

(52) U.S. Cl. 340/5.53; 382/115; 340/5.72; 340/5.61

(57) ABSTRACT

A method of unauthorized access prevention to a restricted object and a biometric security identification system are disclosed. The method comprises steps of sending a restricted object identification signal by its access point, approaching a portable biometric fingerprint-coding device to the access point, receiving this signal by the portable device, switching the portable device to send the biometrical fingerprint coded signal of the user to the approaching access point, verifying whether the received biometric fingerprint coded signal matches one of previously provided by authorized persons. The restricted object identification signal and the biometric fingerprint coded signal are the short-range signals acceptable to prevent them to be eavesdropped and cloned. A biometric security identification system comprises a portable biometric fingerprint-coding device for sending a biometrical fingerprint coded signal of the device user, and an identification manager being set in a restricted object for the coded signal detection and its identification.

### FIELD OF THE INVENTION

The present invention relates to identification security systems and more particularly to a method of unauthorized access prevention to a restricted object and a biometric security identification system.

### BACKGROUND OF THE INVENTION

Various high security systems are using “biometrics identification”, which is a method of measuring and digitizing information which is specific to a given individual, such as fingerprints, facial recognition, palm prints, or iris prints. Once scanned, the information is turned into a digit code/number that is stored in a central database on which the system runs and where the information can be retrieved for evaluation, matching, and acceptance/access.

While the scanning of some body parts is more reliable than other, it is found that fingerprint scanning is by far the most reliable and accurate, so much, that the system can positively identify an individual with an error rate equal to 0.1%.

I have developed a failsafe entry access control, tracking, and wireless portable security system, integrating and incorporating diverse known and new technologies to deliver state of the art, practical and reliable security solutions, which make this system much more versatile and effective than most.

The system can be used on a stand-alone basis or on a fully integrated network system. It is adaptable to be customized to an existing structure with its architecture corresponding, and/or to be used as a new universal system to better suit the needs.

The main problem with the conventional fingerprint identification security systems is that they can be eavesdropped or reverse engineered by unauthorized persons in the phase of communication between the user and restricted object or have a technical problems related to a weather temperature changes such as snow, ice, frost, heat, rain, etc.

There are different devices directed to avoid these problems and some of them are described below.

U.S. Pat. No. 6,078,265 issued to Bonder et al. on Jun. 20, 2000 and U.S. Patent Application Publication No. 2002/0059523 declared by Bacchiaz et al. published on May 16, 2002 disclosed a fingerprint identification security system which is a key-lock operated security system utilizing a fingerprint of an authorized user to control access to the security system, such as the ignition system of an automobile. When an intelligent key is inserted in a lock its enables a data signal to be transmitted from the intelligent key through an electrical contact to a key-lock controller.

U.S. Pat. No. 6,710,700 issued to Tatsukawa et al. on Mar. 23, 2003, U.S. Pat. No. 6,940,391 issued to Ishicura et al. on Sep. 6, 2005, and U.S. Pat. No. 6,868,170 issued to Fuku et al. on Mar. 15, 2005 disclosed a vehicle key system that can be manipulated by user only when an electronic key transmitter is attached to the attaching unit of the vehicle and must have a good electrical contact.

U.S. Pat. No. 6,271,745 issued to Anzai et ai. on Aug. 7, 2001 disclosed a keyless user identification and authorization system for a motor vehicle. The system comprises fingerprint reading units located on the exterior and in the interior of the vehicle for scanning the fingerprint of a user of the vehicle. In this invention the fingerprint-reading units are liable to the weather conditions like snow, ice, rain, etc., and also vandalism actions.

Inventors Hsu et al. in U.S. Pat. No. 6,041,410 issued on Mar. 21, 2000 disclosed a personal identification fob to automatically verify the identity of a person seeking access to a protected property, such as a car, a room, a building, etc. The fob includes a fingerprint sensor and a correlator for comparing the sensed data with a previously stored reference image and for determining whether there is a match. If there is a match, the fob initiates an exchange of signals with the “door” by using a “print” of that signal which contents an authorization signal.

Even as some of the above mentioned systems are practical, all of them suffer from the same principal defect, in that they can be eavesdropped and cloned or may be malfunctioning during multi-seasonal use. This specified defect makes them unusable for high-quality vehicles and secured objects.

Thus, there is a need to develop a biometric security identification system and method of unauthorized access prevention to a restricted object, which can be effectively secured from eavesdropping and cloning by an unauthorized person or thief and is effective in all weather conditions.

### OBJECTS OF THE INVENTION

Accordingly, an object of the present invention is to provide an improved method of unauthorized access prevention to a restricted object and a biometric

A principal object of the present invention is to provide a method of unauthorized access prevention to a restricted object and a biometric security identification system, which cannot be duplicated and misused.

Next object of the present invention is to present a method of unauthorized access prevention to a restricted object and a biometric security identification system which secures only an approved access of the authorized person.

Another object of the present invention is to provide a biometric security identification system that is compact.

One more object of the present invention is to provide a biometric security identification system having a portable biometric fingerprint-coding device that is adaptable to be carried by the user.

Still another object of the present invention is to provide a method of unauthorized access prevention to a restricted object and a biometric security identification system that is adaptable for different restricted objects.

A further object of the present invention is to provide a method of unauthorized access prevention to a restricted object and a biometric security identification system, which includes a portable biometric fingerprint-coding device carried in user body proximity to keep an ambient temperature independently from weather conditions and to prevent vandalism.

Still another object of the present invention is to provide a method of unauthorized access prevention to a restricted object and a biometric security identification system, which is inexpensive.

Other and further objects and advantages of the present invention will be described or will be indicated in the appended claims, and various advantages not referred to herein will occur to one skilled in the art upon employment of the invention in practice.

### SUMMARY OF THE INVENTION

The present invention provides a method of unauthorized access prevention to a restricted object and a biometric security identification system. The restricted object may take a variety of forms, such as a vehicle or any motorized facilities, a building, a financial and security institutions, and the like. For purposes of explanation, the access point has a meaning any door, an ignition system, a car hood or trunk, a computer access system, etc.

According to the present invention, a method of unauthorized access prevention to a restricted object comprises the steps of sending a restricted object identification signal in a “waiting” mode by an access point placed in the restricted object proximity The access point includes a transceiver, a communication microprocessor and an output power device and is a part of an identification manager which also includes a matching device and an energy source; and approaching a portable biometric fingerprint coding device to the access point on a distance equal or less than a range of the identification signal. The portable biometric fingerprint-coding device includes at least one scanner, a communication microprocessor, a transceiver, a switch, and an energy source. When the portable biometric fingerprint-coding device receives the restricted object identification signal, this device can be initiated into a “wake-up” status and switched to a “send” mode for defining its capability to send a biometric fingerprint coded signal. When the user places a finger over the scanner, the point of the identification manager, The matching device than verifies whether the received biometric fingerprint corresponds to one of the signals previously provided by an authorized person during a registration procedure.

When the received biometric fingerprint coded signal correlates with the data stored in the matching device memories, an authorized user is confirmed, and the identification manager allows an access to the restricted object by actuating the output power device.

When the received biometric fingerprint coded signal does not correlate with the data stored in the matching device memories, the access to the restricted object is denied for the unauthorised user. The biometric fingerprint coded signal of the unauthorised user is stocked up in the matching device memories for further identification by the security authority.

It is preferable that the restricted object identification signal and the biometric fingerprint coded signal from the portable biometric fingerprint coding device are the short-range signals acceptable to prevent them to be eavesdropped and cloned. The range of the biometric fingerprint coded signal is equal to or less than the range of the restricted object identification signal.

At least one of the ranges is adjustable thus to ensure that the biometric fingerprint coded signal from the portable biometric coding device is received by only the approaching access point. The range of the biometrical fingerprint coded signal sent by the portable biometric fingerprint-coding device is less than 20 cm, and the range of the identification signals sending by the access point is less than 20 cm as well.

According to another aspect of the present invention, a biometric security identification system comprises an identification manager including at least one access point, a matching device and an energy source, said access point being placed on a restricted object proximity for sending a restricted object identification signal in a “waiting” mode, and includes a transceiver, a communication microprocessor, and an output power device, a portable biometric fingerprint-coding device including at least one biometrical scanner, a communication microprocessor, a transceiver, a switch, and an energy source.

The portable biometric fingerprint coding device, when approached to the access point to a distance equal to or less than a range of the restricted object identification signal, is initiated into a “wake-up” status by receiving the restricted object identification signal and is capable to send a biometric fingerprint coded signal of the user when the user switches the portable biometric fingerprint coding device to “send” mode and places a finger over the scanner. The access point of the identification manager receives the biometric fingerprint coded signal, dispatches it to the matching device to verify whether the received biometric fingerprint coded signal matches one of previously provided by authorized persons during a registration procedure.

When the received biometric fingerprint coded signal correlates with the data stored in the matching device memories, a confirmation of an authorized user is completed and identification manager actuates the output power device for authorized access to the restricted object.

On the contrary, the access to the restricted object will be denied if the user of the portable biometric fingerprint-coding device is unauthorised and the biometric fingerprint coded signal of the unauthorised user will be stocked up in the matching device memories for further identification by the security authority.

It is preferable that the portable biometric fingerprint-coding device could be customized to be carried by the authorized user, to permit to keep an ambient temperature for the portable biometric fingerprint coding device normal function. The portable biometric fingerprint-coding device may have a shape generally matching at least partially the user finger.

It is important that the restricted object identification signal and the biometric fingerprint coded signal are the short-range signals acceptable to prevent them to be eavesdropped and cloned. The range of the biometric fingerprint coded signal preferably is equal to or less than the range of the restricted object identification signal and at least one of the ranges is adjustable thus to make sure that the biometric fingerprint coded signal from the portable biometric coding device is received by only the approaching access point.

The range of the biometrical fingerprint coded signal sent by the portable biometric fingerprint coding device should be less than 20 cm and the range of the identification signals sending by the access point should be less than 20 cm as well.

The invention accordingly comprises the furthers of construction, combination of elements, arrangement of parts of the biometric security identification system, and a method of unauthorized access prevention to a restricted object, which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1a illustrates an identification manager of the biometric security identification system according to the present invention, which includes several access points installed on the vehicle for unauthorized access prevention;

FIG. 1b is illustrates an identification manager of the biometric security identification system according to the present invention, which includes several access points installed on the building for unauthorized access prevention;

FIG. 2 is a principal block diagram showing the biometric security identification system in a “working” position according to the present invention;

FIG. 3 is a functional block-schema of a portable biometric fingerprint-coding device (f-device) according to the present invention;

FIG. 4 is a functional block-schema of the identification manager according to the present invention;

FIG. 5 is a functional block-schema of the biometric security identification system according to the present invention;

FIG. 6 is an exploded perspective view showing an example of the portable biometric coding device according to the present invention;

FIGS. 7a is a back view of a first embodiment of the access point according to the present invention;

FIG. 7b is a front view of the first embodiment of the access point according to the present invention;

FIGS. 8a is a front view of the second embodiment of the access point according to the present invention;

FIG. 8b is a back view of the second embodiment of the access point

FIG. 9 is a perspective view of the portable biometric coding device that has been on at short distance approaching position to one of access point;

FIG. 10 is a perspective view of the portable biometric coding device that has been secured to one of access points to start up the engine of the vehicle or for recharging its energy source;

FIGS. 11a is a perspective view to the portable biometric coding device in a portable position according to the present invention;

FIG. 11b is a perspective view of the portable biometric coding device in a working position according to the present invention;

FIG. 12a is a front view on the portable device in the approaching to the one access point position, according to the first embodiment of the present invention; and

FIG. 12b is a back view on the portable device in the approaching to the one access point position, according to the first embodiment of the present invention.

### DETAILED DESCRIPTION OF THE PREFERRED EMBODIMENTS

With reference to the annexed drawings, the preferred embodiments of the present invention will be herein described for indicative purposes and by no means as of limitation.

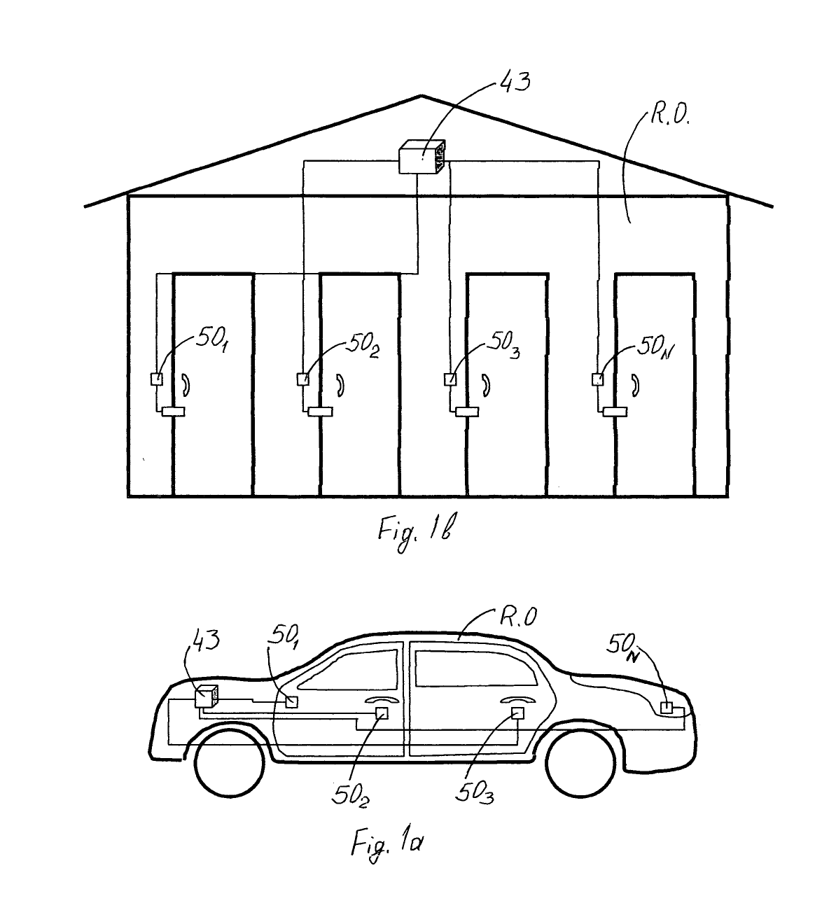

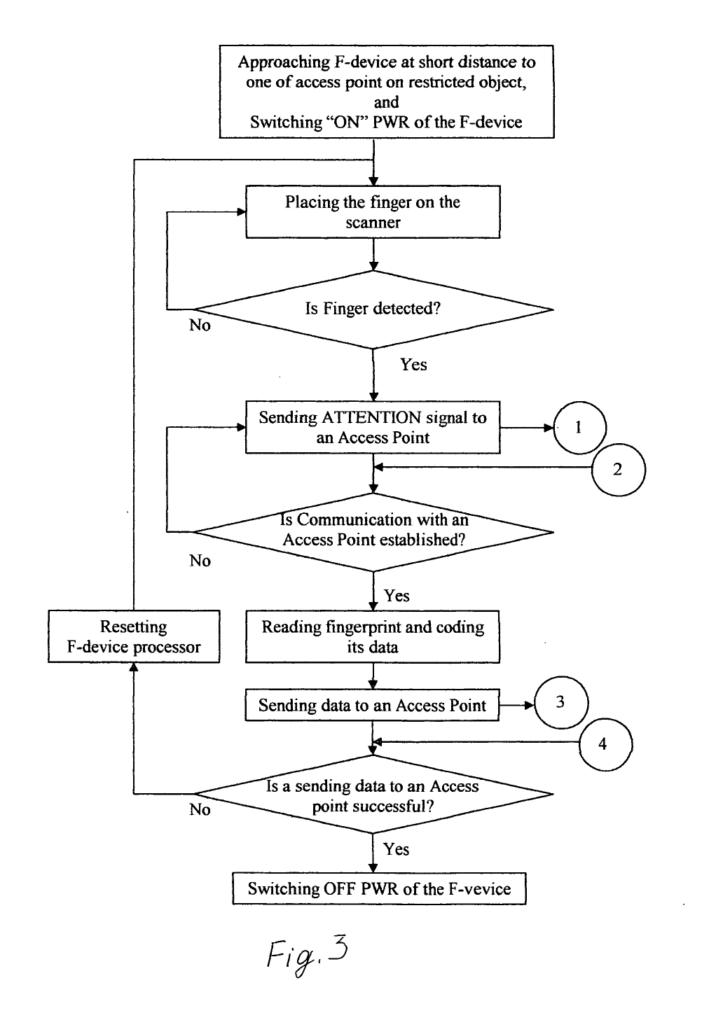

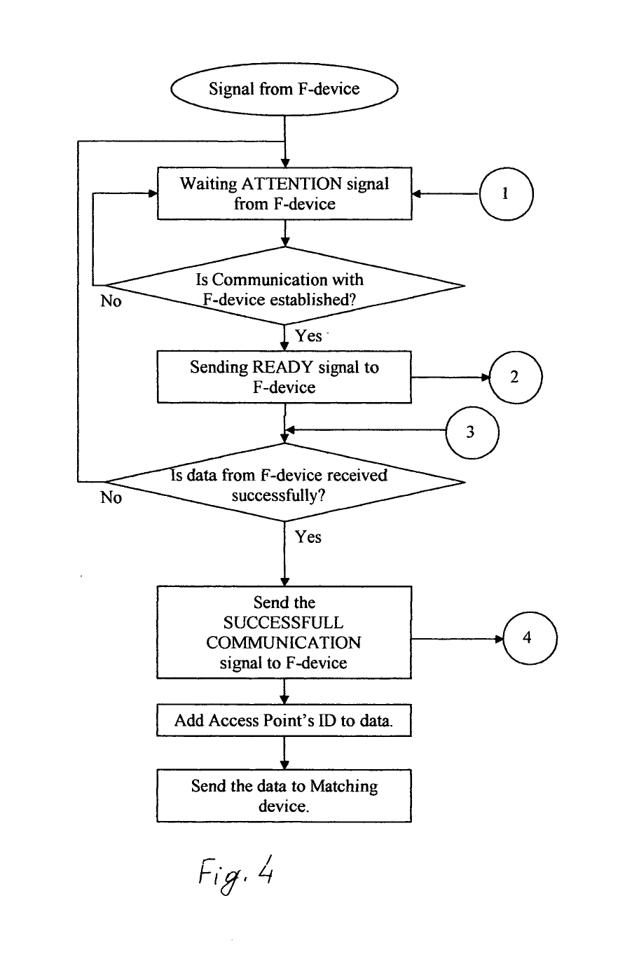

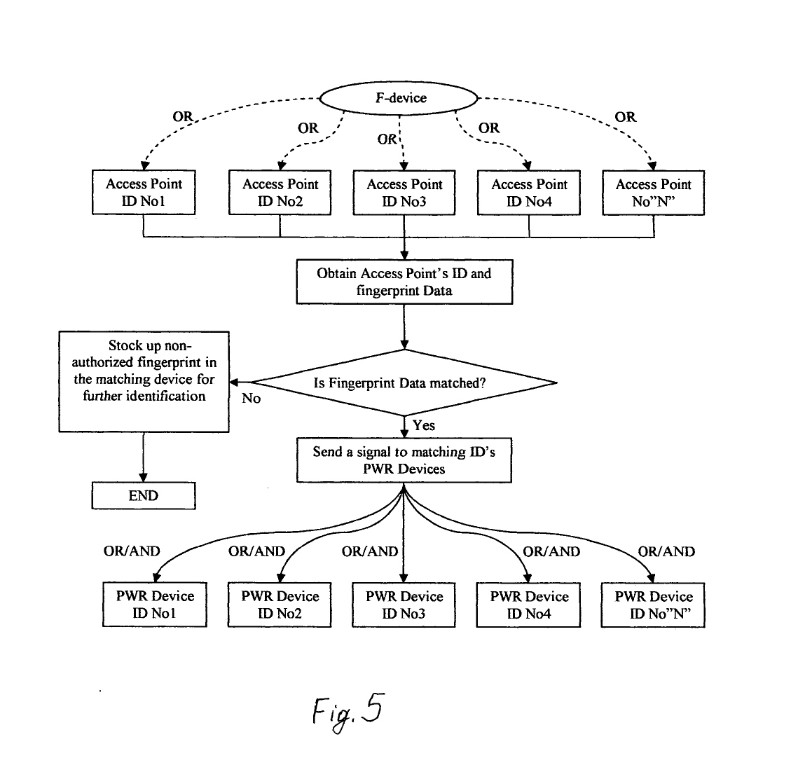

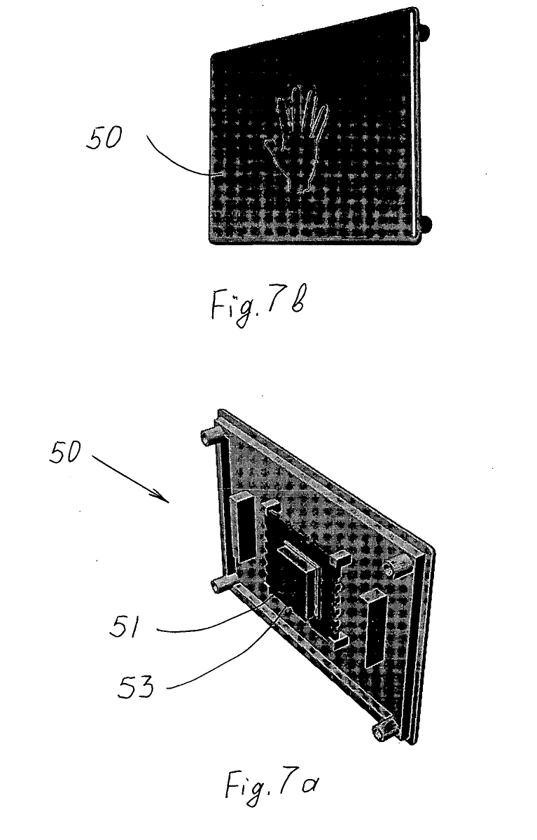

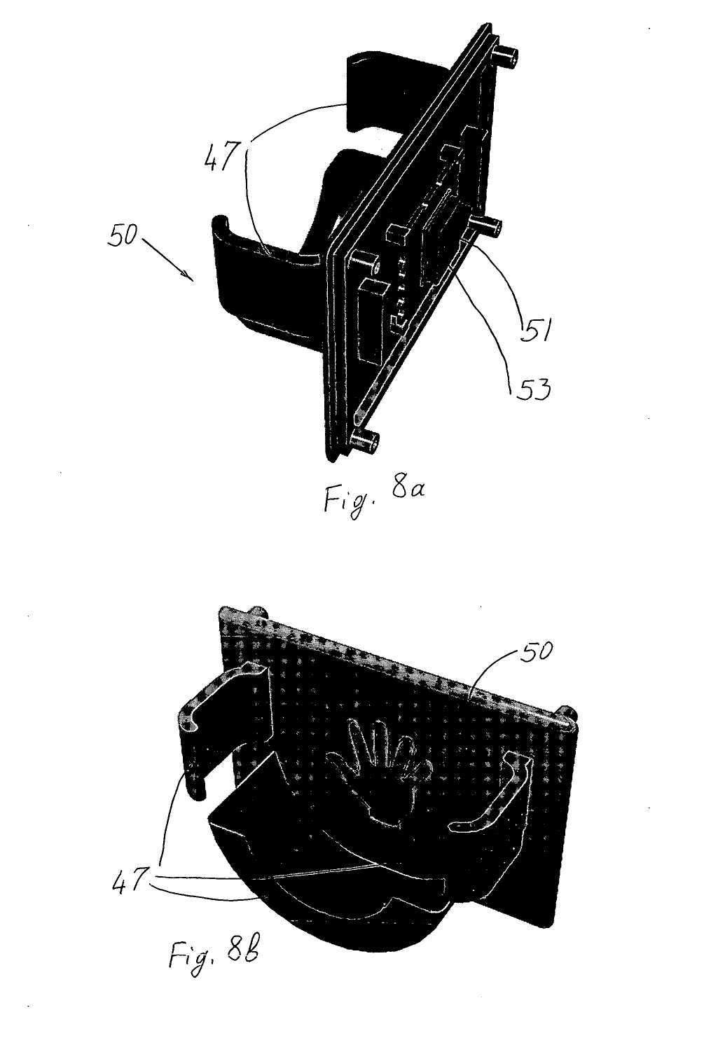

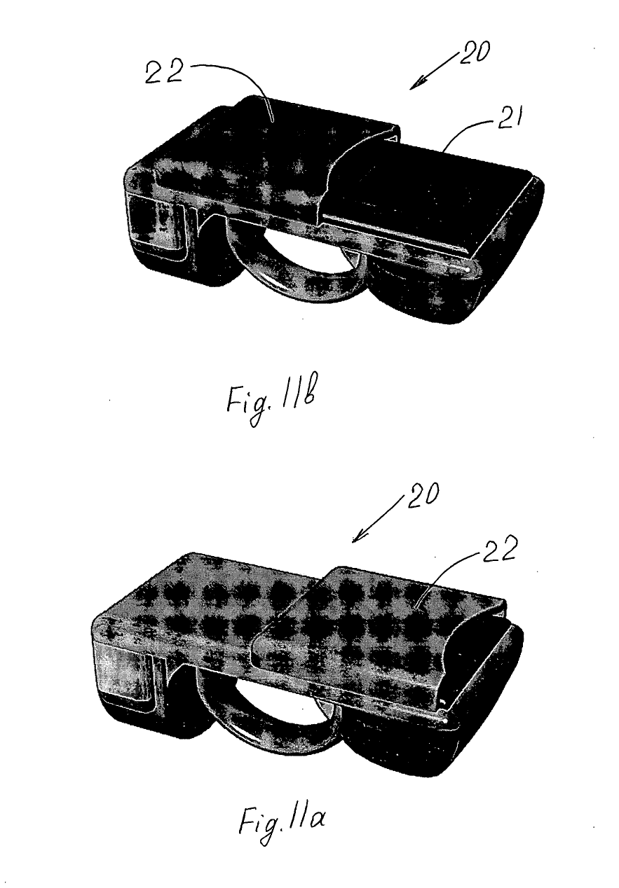

As best shown in FIGS. 1 through 12, the present invention relates to a method of unauthorized access prevention to a restricted object R.O. and to a biometric security identification system that is generally indicated as 10. The biometric security identification system 10 includes a portable biometric fingerprint coding device 20 (F-device) carried by an authorized user and an identification manager 40 securingly placed on the restricted object R.O. facilities.

The method and the system 10 are secure for identifying a person seeking access to the restricted object R.O. such as an automobile (see FIG. 1a), aircraft, ship, building (see FIG. 1b), etc.

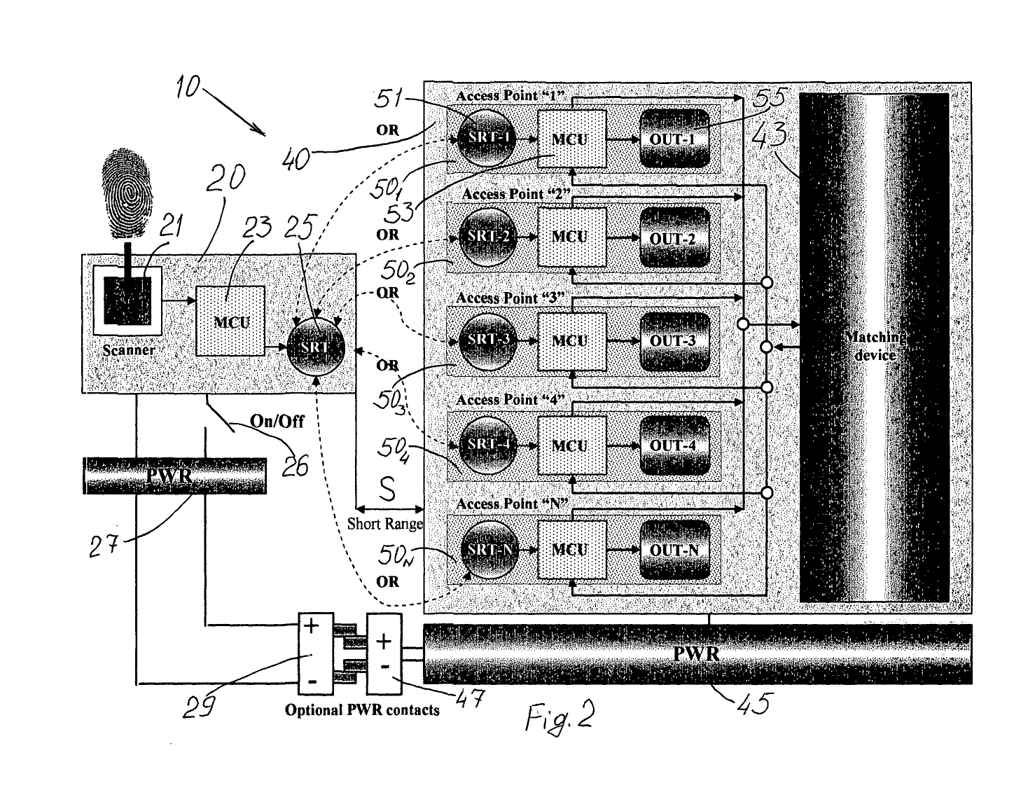

With reference to FIGS. 2-5 there is a novel method of unauthorized access prevention to the restricted object R.O., the present invention comprises the steps of:

Sending a restricted object identification signal in a “waiting” mode by an access point 50₁-50_{N} placed on the restricted object R.O. proximity. Each of the access points 50₁-50_{N} includes a transceiver 51, a communication microprocessor 53 and an output power device 55 and is a part of the identification manager 40, which also includes a matching device 43 and an energy source 45.

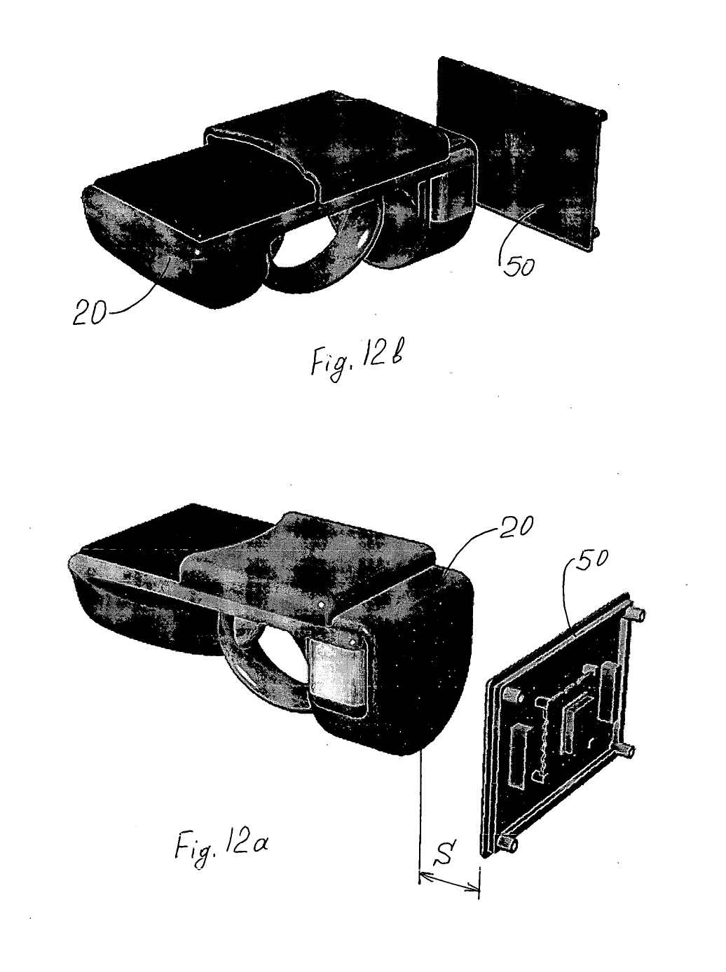

Approaching the portable biometric fingerprint-coding device 20 to the necessary access point 50 to a distance (see FIGS. 2 and 12a) that is equal or less than a range S of the identification signal. The portable biometric fingerprint-coding device 20 includes at least one scanner 21, a communication microprocessor 23, a transceiver 25, a switch 26, and an energy source 27.

Receiving the restricted object R.O. identification signal by the portable biometric fingerprint coding device 20 and initiating this device 20 into a “wake-up” status.

Switching the portable biometric fingerprint-coding device 20 to a “send” mode to allow it to send a biometric fingerprint coded signal.

Sending the biometrical fingerprint coded signal of the user to the approaching access point 50 when the user places a finger over the scanner 21.

Receiving the biometric fingerprint coded signal by the access point 50 of the identification manager 40.

Dispatching the biometric fingerprint coded signal from the access point 50 to the matching device 43 of the identification manager 40.

Verifying by the matching device 43 whether the received biometric fingerprint coded signal matches one of the signals previously provided by an authorized person during a registration procedure.

Confirming an authorized user when the received biometric fingerprint coded signal correlates with the data stored in the matching device 43 memories, and actuating the output power device 55 for authorized access to the restricted object R.O.

Denying access to the restricted object R.O. if the user of the portable biometric fingerprint-coding device 20 is unauthorised, when the received biometric fingerprint coded signal does not correlate with the data stored in the matching device 43 memories.

Stocking up the biometric fingerprint coded signal of the unauthorised user in the matching device 43 memories for further identification by the security authority.

The restricted object R.O. identification signal and the biometric fingerprint coded signal from the portable biometric fingerprint coding device 20 are the short-range signals acceptable to prevent them to be eavesdropped and cloned. The range of the biometric fingerprint coded signal is equal to or less than the range of the restricted object R.O. identification signal. At least one of the ranges is adjustable thus to ensure that the biometric fingerprint coded signal from the portable biometric coding device 20 is received by only the approaching access point 50.

The range of the biometrical fingerprint coded signal sent by the portable biometric fingerprint-coding device 20 should be less than 20 cm and the range of the identification signals sending by the access point 50 should be less than 20 cm.

Referring to FIGS. 2, 6-12, the biometric security identification system 10 includes the portable device 20 that is practically carried by an authorized user to define the biometric identification signal and send it to the restricted facility, and the identification manager 40 placed on the restricted facility to receive and process a biometric identification signal to accept or reject an access.

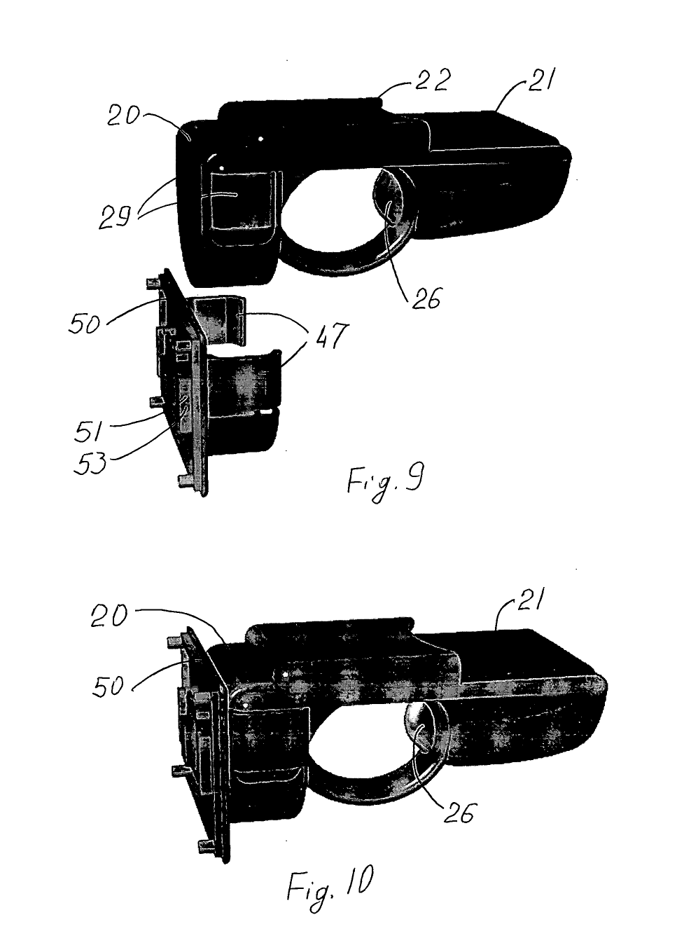

The portable device 20 and the identification manager 40 are constructed to have a mutual short-range security communication distance. Preferably that range could be adjustable on short possible communication distance from “0” (see FIG. 10) to a few centimetres (see FIGS. 9 and 12) to prevent eavesdropping of this communication and as a result to protect the restricted object R.O. from unauthorized access.

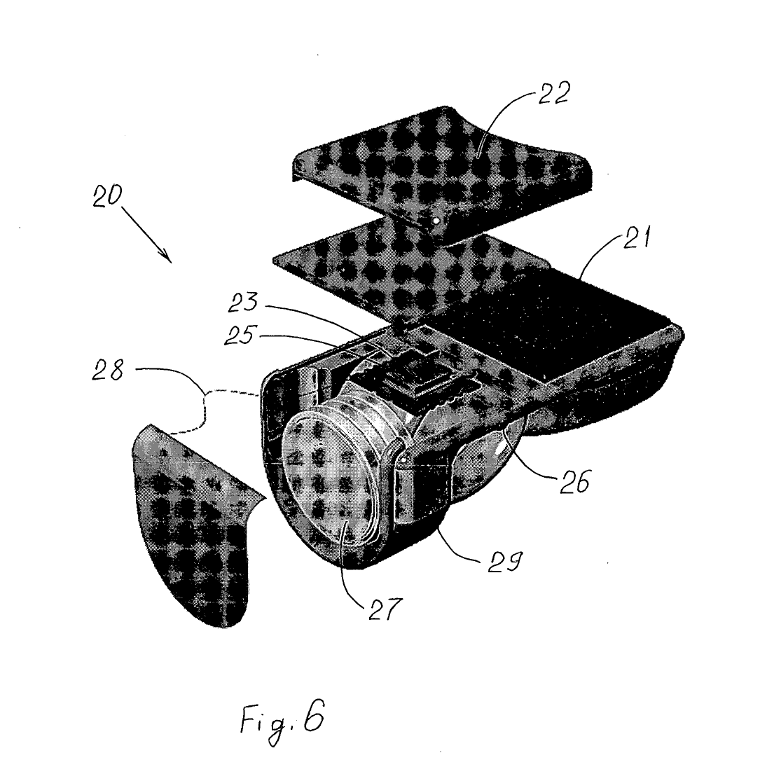

The portable device 20 (see FIG. 6) includes a biometric scanner 21 enclosing an encoding processor, a communication microprocessor 23, a short-range transceiver 25, a switch 26, an energy source 27, an antenna 28 and a connector 29.

As shown on FIG. 2 the identification manager 40 contains at least one access point 50, a matching device 43 for the user's identification and access confirmation, and energy source 45. The access point 50 comprises a short-range transceiver 51, a communication microprocessor 53, and an output power device 55. The matching device 43 determines whether the fingerprint image of the user seeking access matches with the fingerprint image of the authorized user.

When there is no short-range communication with the portable device 20, the identification manager 40 is working in a “waiting” position as a beacon, sending short-range periodical signals (FIG. 2).

As soon as the portable biometric fingerprint coding device 20 is approached at the short distance to the access point 50 of the restricted object, the portable biometric fingerprint coding device 20 is switched “ON”, to commence a “wake-up” signal received from the short range transceiver 51 of the identification manager 40, and is able to send the fingerprint coded measurements obtained from the scanner 21 to the identification manager 40 when a person seeking access to the protected facility places a finger over this scanner 21.

When the person seeking access to the protected facility presses the scanner 21, a coding of the user's fingerprint is produced, the microprocessor 23 receives this information from the scanner 21, and a short range signal is created by the short range transceiver 25 to exchange information with the short range transceiver 51 of the access point 50.

The signal with the user's fingerprint information is transmitted from the portable device 20 to the access identification manager 40. The access identification manager 40 provides the access to the restricted object upon the matching device 43 confirming that the transmitted signal with the fingerprint is the same as one previously provided by an authorized person during a registration procedure.

If the fingerprint image does not correlate with the data stored in the matching device 43, the access of the unauthorised person is not allowed. The unauthorized fingerprint image is stocked up in the matching device 43 memories for further identifications of the suspect by the security authority.

The authorized person very often carries the portable device 20 on his body as key for access to the restricted facilities. That allows to keep an ambient temperature for normal function of the devices 20 and using it in any climatic temperature ranges. It also allows to avoid the security system degradation or loss of functionality by external high-energy electrostatic charges because of the same charge as the body.

Referring to FIGS. 6, 9-12, the portable biometric fingerprint-coding device 20 has a special movable shield 22 to protect the fingerprint-scanning device 21 from scratching during carrying. User might open the shield 22 when it is necessary to have an access to the fingerprint-scanning device 21.

The portable biometric fingerprint coding device 20 might use a different source, as for example a battery 27 (see FIGS. 2 and 6), or an ultraviolet, an infrared, a laser, a sound, RF, etc.

Soon after the authorized user accesses, the identification manager 40 turns back into the “waiting” position to start working as beacon. The identification manager 40 will also turn back into the “waiting” position as a beacon if the authorized user does not access the restricted facility after a certain time.

The biometric security identification system 10 according to the present invention is easy adaptable to be customized to existing security structures to better suit the customer's needs.

All this makes this system 10 much more versatile and effective than existing systems.

Referring to FIGS. 2, 6, 8 and 9, it is shown that the portable biometric fingerprint coding device 20 has a connector 29 to be securely engaged to an answering part 47 of the access point 50 for switching the ignition “ON” and recharging during a trip inside the vehicle, or to be connected to any power supplier for its recharging from a battery, restricted facility power source, home current, etc.

The biometric security identification system 10 could have a different ergonomic shape (see FIGS. 6 to 12). The portable biometric fingerprint-coding device 20 may have small handheld dimensions and could be equipped by a fastener (not shown) to connect the portable biometric fingerprint-coding device 20 to a user finger or other part of the human body.

In the registration mode, the identification manager 40 can store the user's fingerprint in association with the user's name or/and other identifying information.

The identification manager 40 could be provided with an over-ride switching device (not shown) to disable temporarily the security system 10 in special cases as, for example for valet parking, mechanical repair of the vehicle, etc. In this case, the access to the vehicle may be established for any temporary user of the portable biometric fingerprint-coding device 20. The fingerprint of this user might be also transmitted from the portable biometric fingerprint-coding device 20 and be collected by the identification manager 40.

It is appreciated from this description that this invention provides a new and reliable method of unauthorized access prevention to a restricted object and biometric security identification system.

The invention allows to utilize the portable biometric fingerprint-coding device 20 under rigorous environmental conditions without using a special enclosure to keep the ambient temperature that is usually necessary for normal functioning of its fingerprint-scanning device 21 when a fingerprint-scanning device is installed on the object.

In particular, it will be possible to use these devices without any enclosure for car access applications (for example, front or rear doors, trunk and hood or/and switch on an ignition system, etc.).

The drawings and the description attached to it are only intended to illustrate the idea of the invention. As to the details, the invention may vary within the scope of the claims. So, the shape or size of the biometric security identification system may be formed as desired, considering the needs and specifics of restricted objects.

Although the present biometric security identification system and method of unauthorized access prevention to a restricted object have been described with a certain degree of particularity it is to be understood that the disclosure has been made by way of example only and that the present invention is not limited to the features of the embodiment(s) described and illustrated herein, but includes all variations and modifications within the scope and spirit of the invention as hereinafter claimed.

What is claimed is:

1. A method of unauthorized access prevention to a restricted object, comprising the steps of:
sending a restricted object identification signal in a “waiting” mode by an access point been placed on the restricted object proximity, said access point including a transceiver, a communication microprocessor and an output power device and is a part of an identification manager which also includes a matching device and an energy source;
approaching a portable biometric fingerprint coding device to the access point to a distance equal or less than a range of the identification signal, said portable biometric fingerprint coding device including at least one scanner, a communication microprocessor, a transceiver, a switch, and an energy source;
receiving the restricted object identification signal by the portable biometric fingerprint coding device and initiating this device into a “wake-up” status;
switching the portable biometric fingerprint-coding device in a “send” mode to enable it to send a biometric fingerprint coded signal;
sending the biometrical fingerprint coded signal of the user to the approaching access point when the user places a finger over the scanner;
receiving the biometric fingerprint coded signal by the access point of the identification manager;
dispatching the biometric fingerprint coded signal from the access point to the matching device of the identification manager;
verifying by the matching device whether the received biometric fingerprint coded signal corresponds with one of previously provided by one of the authorized persons during a registration procedure;
confirming of an authorized user when the received biometric fingerprint coded signal do correlates with the data stored in the matching device memories, and actuating the output power device for authorized access to the restricted object;
denying access to the restricted object if the user of the portable biometric fingerprint-coding device is unauthorised, when the received biometric fingerprint coded signal does not correlate with the data stored in the matching device memories;
stocking up the biometric fingerprint coded signal of the unauthorised user in the matching device memories for further identification by the security authority.

2. The method, according to claim 1, wherein the restricted object identification signal and the biometric fingerprint coded signal from the portable biometric fingerprint coding device are short-range signals designed to prevent them to be eavesdropped and cloned.

3. The method, according to claim 2, wherein the range of the biometric fingerprint coded signal is equal or less than the range of the restricted object identification signal.

4. The method, according to claim 3, wherein at least one of the ranges is adjustable thus to secure that the biometric fingerprint coded signal from the portable biometric coding device is received by only the approaching access point.

5. The method, according to claim 4, wherein the range of the biometrical fingerprint coded signal sent by the portable biometric fingerprint-coding device is less than 20 cm.

6. The method, according to claim 5, wherein the range of the identification signals sent by the access point is less than 20 cm.

7. A biometric security identification system, comprising:
an identification manager including at least one access point, a matching device and an energy source, said access point being placed in a proximity to the restricted object, for sending a restricted object identification signal in a “waiting” mode, and including a transceiver, a communication microprocessor, and an output power device,
a portable biometric fingerprint-coding device including at least one biometrical scanner, a communication microprocessor, a transceiver, a switch, and an energy source,
wherein the portable biometric fingerprint coding device, when approached to the access point on a distance equal or less than a range of the restricted object identification signal, is initiating into a “wake-up” status by receiving the restricted object identification signal and is capable to send a biometric fingerprint coded signal of the user at what time the user switches the portable biometric fingerprint coding device to a “send” mode and places a finger over the scanner. The access point of the identification manager receives the biometric fingerprint coded signal, dispatches it to the matching device for verification whether the received biometric fingerprint coded signal corresponds to one of the signals previously provided by authorized persons during a registration procedure, confirms an authorized user when the received biometric fingerprint coded signal correlates with the data stored in the matching device memories, and actuates the output power device to authorize access to the restricted object, or denies the access to the restricted object if the user of the portable biometric fingerprint coding device is unauthorised, when the received biometric fingerprint coded signal does not correlate with the data stored in the matching device memories, the biometric fingerprint coded signal of the unauthorised user is stocked up in the matching device memories for further identification by the security authority.

8. The biometric security identification system according to claim 7, wherein the portable biometric fingerprint coding device is customized to be carried by the authorized user, which allows to keep an ambient temperature for the portable biometric fingerprint coding device normal function.

9. The biometric security identification system, according to claim 8, wherein the portable biometric fingerprint coding device has a shape generally matching at least partially the user's finger.

10. The biometric security identification system, according to claim 9, wherein the restricted object identification signal and the biometric fingerprint coded signal are the short-range signals acceptable to prevent them to be eavesdropped and cloned.

11. The biometric security identification system, according to claim 10, wherein the range of the biometric fingerprint coded signal is equal to or less than the range of the restricted object identification signal.

12. The biometric security identification system, according to claim 11, wherein at least one of the ranges is adjustable thus to secure that the biometric fingerprint coded signal from the portable biometric coding device is received by only the approaching access point.

13. The biometric security identification system, according to claim 12, wherein the range of the biometrical fingerprint coded signal sent by the portable biometric fingerprint-coding device is less than 20 cm.

14. The biometric security identification system, according to claim 13, wherein the range of the identification signals sent by the access point is less than 20 cm.
